(19) United States
(12) Patent Application Publication
(10) Pub. No.: US 2026/0101154 A1
(43) Pub. Date: Apr. 9, 2026

(54) METHOD AND SYSTEM

(71) Applicant: TOYOTA JIDOSHA KABUSHIKI KAISHA, Toyota-shi (JP)

(72) Inventor: Takafumi KUWAHARA, Okazaki-shi (JP)

(73) Assignee: TOYOTA JIDOSHA KABUSHIKI KAISHA, Toyota-shi (JP)

(21) Appl. No.: 19/294,573

(22) Filed: Aug. 8, 2025

(30) Foreign Application Priority Data
Oct. 7, 2024 (JP) 2024-176109

(51) Int. Cl. H04W 4/029; G06F 16/9537; H04W 4/44

(52) U.S. Cl. CPC H04W 4/029; G06F 16/9537; H04W 4/44

(57) ABSTRACT

A method is performed by a system, including a vehicle and a server, that is configured to provide content to an occupant of the vehicle while the vehicle is stopped. The method includes acquiring, by the vehicle, a location and a travel speed of the vehicle, detecting, by the vehicle, a stop state of the vehicle based on the travel speed of the vehicle, and transmitting, by the vehicle to the server, stop history information including a stop location and a stop time, when a stop duration during which the stop state of the vehicle has continued is equal to or longer than a certain period of time.

### CROSS-REFERENCE TO RELATED APPLICATION

This application claims priority to Japanese Patent Application No. 2024-176109 filed on October 7, 2024, the entire contents of which are incorporated herein by reference.

### TECHNICAL FIELD

The present disclosure relates to a method and a system.

### BACKGROUND

Technology for providing content to occupants of vehicles while the vehicles are stopped is known. For example, Patent Literature (PTL) 1 discloses technology in which a current stop scene is determined from multiple stop scenes based on the state of a vehicle and map information, and which information to provide to a driver is determined according to the current stop scene.

### CITATION LIST

### Patent Literature

PTL 1: JP 2010-168016 A

### SUMMARY

In the above method, it is not always possible to foresee a stop duration of a vehicle at each stop scene. Therefore, for example, when the stop duration is short and the vehicle should start quickly, presenting content that is not essential during driving may lead to driver distraction. Thus, there is room for improvement in technology for providing content to occupants of vehicles while the vehicles are stopped.

It would be helpful to improve technology for providing content to occupants of vehicles while the vehicles are stopped.

A method according to an embodiment of the present disclosure is a method performed by a system including a vehicle and a server, the system configured to provide content to an occupant of the vehicle while the vehicle is stopped, the method including: acquiring, by the vehicle, a location and a travel speed of the vehicle; detecting, by the vehicle, a stop state of the vehicle based on the travel speed of the vehicle; and transmitting, by the vehicle to the server, stop history information including a stop location and a stop time, when a stop duration during which the stop state of the vehicle has continued is equal to or longer than a certain period of time.

A system according to an embodiment of the present disclosure is a system including: a vehicle; and a server, wherein the system is configured to provide content to an occupant of the vehicle while the vehicle is stopped, the vehicle is configured to: acquire a location and a travel speed of the vehicle; detect a stop state of the vehicle based on the travel speed of the vehicle; and transmit stop history information including a stop location and a stop time to the server, when a stop duration during which the stop state of the vehicle has continued is equal to or longer than a certain period of time.

According to an embodiment of the present disclosure, technology for providing content to occupants of vehicles while the vehicles are stopped is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a flowchart illustrating a flow of transmitting stop history information to a server of the system according to the embodiment of the present disclosure;

FIG. 3 is a flowchart illustrating a flow of storing stop history information in the server of the system according to the embodiment of the present disclosure;

FIG. 4 is a flowchart illustrating a flow of providing content in the system according to the embodiment of the present disclosure;

FIG. 5 is a flowchart illustrating a flow of determining details on content to be provided by the system according to the embodiment of the present disclosure;

FIG. 6 is a diagram illustrating a content provision screen of the system according to the embodiment of the present disclosure; and

FIG. 7 is a diagram illustrating stop history information to be transmitted to the server of the system according to the embodiment of the present disclosure.

### DETAILED DESCRIPTION

Hereinafter, an embodiment of the present disclosure will be described.

### Outline of Embodiment

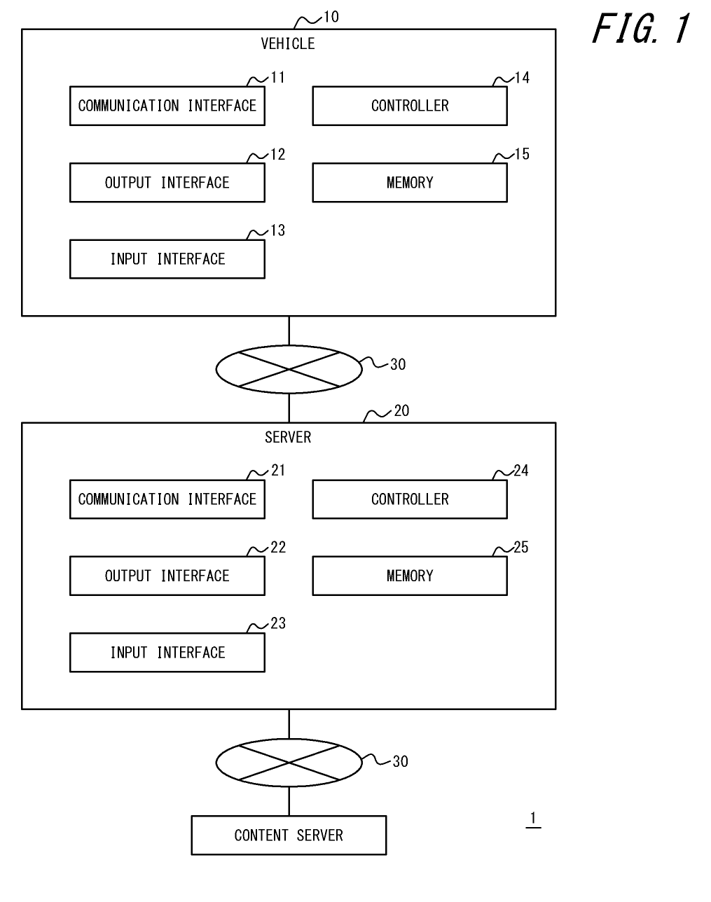

An outline of a system according to the embodiment of the present disclosure will be described with reference to FIG. 1. A system 1 includes a vehicle 10 and a server 20. The system 1 can be used to provide content (for example, video content, music content, or the like) to an occupant (for example, driver) of the vehicle 10. The vehicle 10 and the server 20 are communicably connected with a network 30 including, for example, the Internet, a mobile communication network, and the like. The server 20 can acquire content to be provided to an occupant of the vehicle 10 from any content server using the network 30, which includes, for example, the Internet, a mobile communication network, and the like.

The vehicle 10 is an automobile, for example, but is not limited to this and may be any appropriate vehicle. The automobile is, for example, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 included in the system 1 may be freely determined.

The server 20 is a computer or multiple computers that can communicate with each other, and can communicate with the vehicle 10 via the network 30.

First, an outline of the present embodiment will be described, and details thereof will be described later. The system 1, which includes the vehicle 10 and the server 20, provides content to an occupant of the vehicle 10. The vehicle 10 acquires a location and a travel speed of the vehicle 10. The vehicle 10 detects a stop state of the vehicle 10 based on the travel speed of the vehicle 10. Then, when a stop duration during which the stop state of the vehicle 10 has continued is equal to or longer than a certain period of time, the vehicle 10 transmits, to the server 20, stop history information including a stop location and a stop time.

Here, providing content to an occupant of the vehicle 10 while the vehicle 10 is stopped is considered. As described above, for example, providing content in a relatively short stop duration may cause driver distraction. In addition, depending on a location at which the vehicle 10 is stopped, the tendency of a stop duration may vary. For example, on roads in which traffic congestion is likely to occur, a stop duration tends to be longer than on roads in which traffic congestion is less likely to occur. According to the present embodiment, when a stop state of the vehicle 10 has been kept for a certain period of time, stop history information including a stop location and a stop time is transmitted to the server 20. That is, the server 20 stores stop history information that includes locations at which occupants of the vehicle 10 have been actually stopped for the certain period of time or more (i.e., at which stop durations have been relatively long). Such stop history information stored in the server 20 is useful for content provision. In other words, at the time of providing content to an occupant of the vehicle 10 while the vehicle 10 is stopped, for example, when a stop location at which the vehicle 10 is stopped approximately matches with any stop location indicated in the stop history information stored in the server 20, a stop duration of the vehicle 10 is likely to be equal to or longer than the certain period of time. Therefore, as described above, using the stop history information stored in the server 20 makes it possible to, for example, prevent a situation in which content is provided to an occupant at a stop location with a relatively short stop duration and this results in driver distraction, thereby improving technology for providing content to occupants of vehicles.

Next, configurations of the system will be described in detail.

### Configuration of Vehicle

As illustrated in FIG. 1, the vehicle 10 includes a communication interface 11, an output interface 12, an input interface 13, a controller 14, and a memory 15.

The communication interface 11 includes at least one communication interface for connecting to the network 30. The communication interface is compliant with a mobile communication standard such as the 4th generation (4G) standard or the 5th generation (5G) standard, for example, but is not limited to these. In the present embodiment, the vehicle 10 communicates with the server 20 via the communication interface 11 and the network 30.

The output interface 12 includes at least one output device for outputting information. The output device is, for example, a display, a speaker, or the like, but is not limited to these. Alternatively, the output interface 12 may include an interface for connecting to an external output device.

The input interface 13 includes at least one input device for detecting user input. The input device is, for example, a physical key, a capacitive key, a pointing device such as a mouse, a touch screen integrally provided with a display of the output interface 12, a microphone for accepting audio input, or the like, but is not limited to these. Alternatively, the input interface 13 may include an input interface for detecting user input via an external input device.

The controller 14 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 14 controls operations of the entire vehicle 10.

The memory 15 includes one or more memories. The memories are, for example, semiconductor memories, magnetic memories, optical memories, or the like, but are not limited to these. The memories included in the memory 15 may each function as, for example, a main memory, an auxiliary memory, or a cache memory. The memory 15 stores any information used for the operations of the vehicle 10. For example, the memory 15 may store a system program, an application program, embedded software, and the like. The information stored in the memory 15 may be updated with, for example, information acquired from the network 30 via the communication interface 11.

### Configuration of Information Processing Apparatus

As illustrated in FIG. 1, the server 20 includes a communication interface 21, an output interface 22, an input interface 23, a controller 24, and a memory 25.

The communication interface 21 includes at least one communication interface for connecting to the network 30. The communication interface is compliant with, for example, but not limited to, a mobile communication standard, a wired local area network (LAN) standard, or a wireless LAN standard, and may be compliant with any appropriate communication standard. In the present embodiment, the server 20 communicates with the vehicle 10 via the communication interface 21 and the network 30. In addition, the server 20 may acquire external content via the communication interface 21 and the network 30.

The output interface 22 includes at least one output device for outputting information. The output device is, for example, a display, a speaker, or the like, but is not limited to these. Alternatively, the output interface 22 may include an interface for connecting to an external output device.

The input interface 23 includes at least one input device for detecting user input. The input device is, for example, a physical key, a capacitive key, a pointing device such as a mouse, a touch screen integrally provided with a display of the output interface 22, a microphone for accepting audio input, or the like, but is not limited to these. Alternatively, the input interface 23 may include an input interface for detecting user input via an external input device.

The controller 24 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 24 controls operations of the entire server 20.

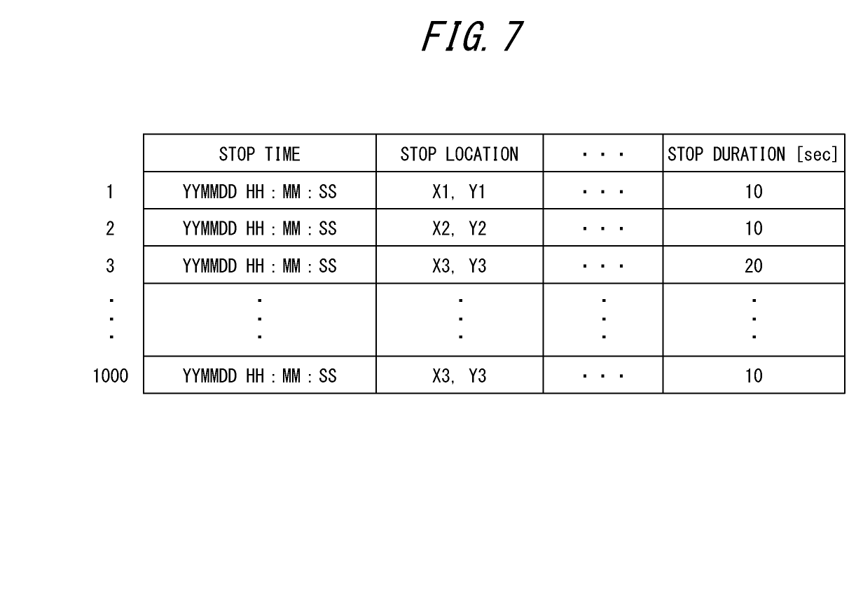

The memory 25 includes one or more memories. The memories included in the memory 25 may each function as, for example, a main memory, an auxiliary memory, or a cache memory. The memory 25 stores any information used for the operations of the server 20. Moreover, the memory 25 includes a database that stores stop history information on the vehicle 10. FIG. 7 illustrates an example of the database for the stop history information. The database includes, for example, stop times, stop locations, and stop durations. The upper limit on the number of records that the database can store can be any number. Stop history information received from the vehicle 10 is compared with the stop history information stored in the database, and is stored in the database as new stop history information when at least one item of the information, other than a stop time, differs. On the other hand, stop history information received from the vehicle 10 is compared with the stop history information stored in the database, and when all items of the stop history information, other than a stop time, matches with a piece of the stop history information stored in the database, the database is updated by overwriting the piece of the stop history information having an old stop time. The stop history information may further include any information, such as traffic volume information for a time zone of the stop time and at the stop location. The time zone of the stop time may include any time zone, such as weekdays or holidays, commuting hours, daytime or nighttime outside of commuting hours. The memory 25 may also store, for example, a system program, an application program, embedded software, map information, and the like.

### Flow of Operations of Information Processing Apparatus

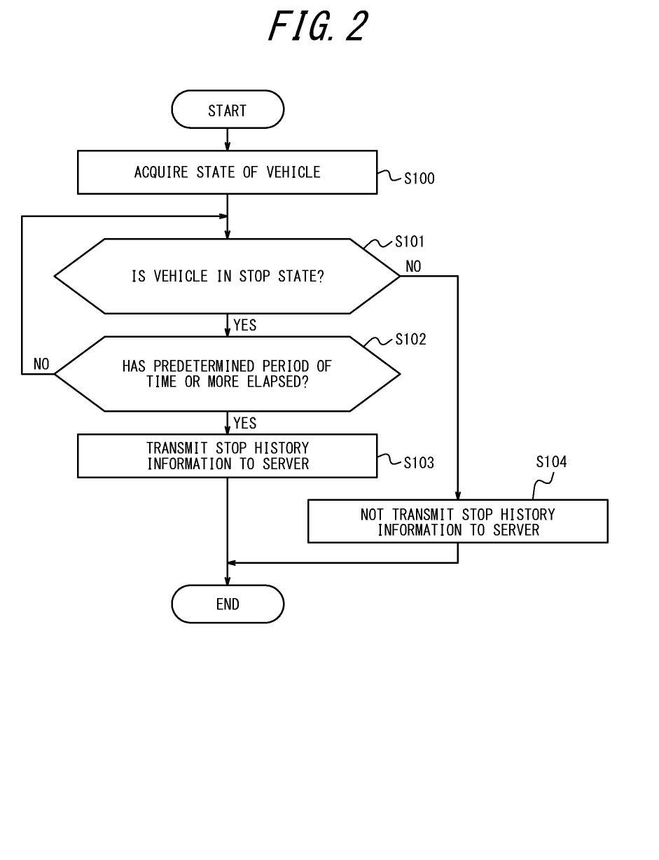

With reference to FIG. 2, operations of transmitting stop history information on the vehicle 10 to the server 20 according to the present embodiment will be described.

S100: The controller 14 of the vehicle 10 acquires a location and a travel speed of the vehicle 10.

The method for acquiring the location and the travel speed of the vehicle 10 is, for example, a method acquired via CAN, but is not limited to this, and any method can be adopted.

S101: The controller 14 detects a stop state of the vehicle 10 based on the travel speed of the vehicle 10.

The controller 14 may determine that the vehicle 10 is in a stop state when the travel speed of the vehicle 10 is equal to or lower than a predetermined value. When the vehicle 10 is repeatedly stopping and moving for a short time due to traffic congestion, the controller 14 may also determine that the vehicle 10 is in a stop state. Furthermore, the vehicle 10 may check the state of surrounding vehicles (congestion conditions), and determine that the vehicle 10 is in a stop state based on the speed of the vehicle 10 and the state of the surrounding vehicles. Any method can be employed to acquire the state of the surrounding vehicles. The controller 14 executes S102 upon determining that the vehicle 10 is in a stop state, whereas the controller 14 executes S104 upon determining that the vehicle 10 is not in a stop state.

S102: The controller 14 determines whether a stop duration during which the stop state of the vehicle 10 has been continued is equal to or longer than a certain period of time.

The certain period of time can be set freely. For example, an average time required for providing content may be adopted. When the stop duration is equal to or longer than the certain period of time, S103 is executed. On the other hand, when the stop state has not been kept for the certain period of time, S101 is executed again.

S103: When the stop duration of the vehicle 10 is equal to or longer than the certain period of time, the controller 14 transmits stop history information to the server 20.

The stop history information includes, for example, a stop location and a stop time of the vehicle 10, but is not limited to this. For example, the stop history information may further include any information, such as the stop duration of the vehicle 10, or traffic volume information for a time zone and day of the week of the stop time, and at the stop location. By storing the time zone and day of the week of the stop time in the database, it is possible to consider weekdays or holidays, peak commuting hours or low traffic daytime, and to store more accurate stop history information in the database.

S104: When the stop duration of the vehicle 10 is not equal to or longer than the certain period of time, the controller 14 does not transmit stop history information to the server 20.

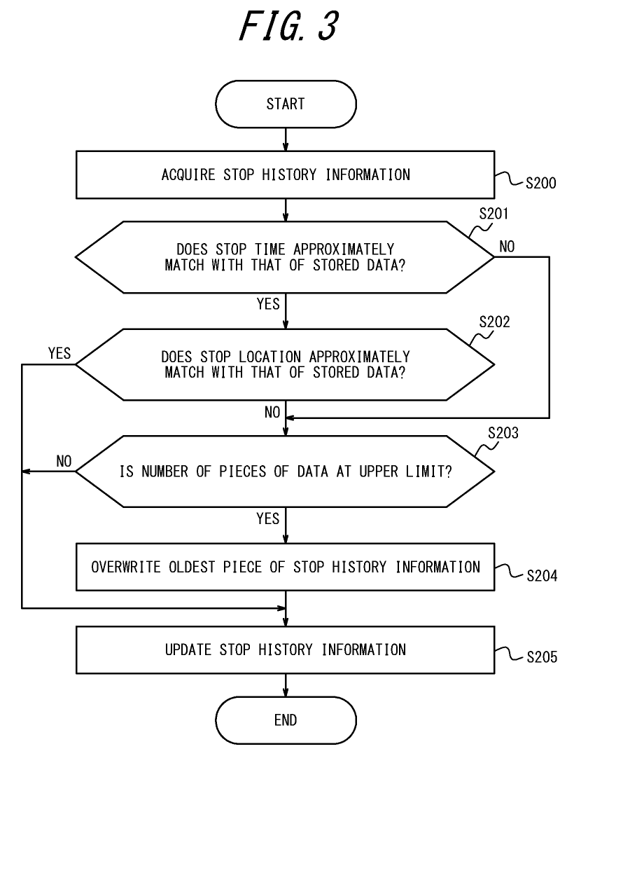

With reference to FIG. 3, operations of storing stop history information in the server 20 according to the present embodiment will be described.

S200: The controller 24 of the server 20 receives stop history information from the vehicle 10.

Here, for example, when the stop history information does not include traffic volume information and a time zone of a stop time, the server 20 may determine, based on a stop location and a stop time included in the stop history information received from the vehicle 10, traffic volume information at the stop location and a time zone of the stop time. This allows for a reduction in communication volume and communication cost.

S201: The controller 24 determines whether there is, in the database, another piece of stop history information whose stop time approximately matches with that of the received stop history information.

In the present embodiment, two stop times "approximately matching" do not require the both times to match exactly. For example, when the difference between the two stop times is less than a predetermined threshold, or when, out of hours and minutes of the two stop times, the hours of the two stop times match, the both times may be determined to approximately match. When there is another piece of stop history information in the database stored in the server 20, S202 is executed. On the other hand, when there is not another piece of stop history information in the database stored in the server 20, S203 is executed. Therefore, for example, when the vehicle 10 repeatedly stops and moves due to traffic congestion, it is possible to prevent multiple pieces of stop history information for the same congestion section from being stored in the database.

S202: The controller 24 determines whether there is, in the database, another piece of stop history information whose stop location approximately matches with that of the received stop history information.

In the present embodiment, two stop locations "approximately match" does not require the both locations to match exactly. For example, when the distance between the two stop locations is less than a predetermined threshold, or when the two stop locations are present on a single road, the both locations may be determined to approximately match. When there is another piece of stop history information in the database stored in the server 20, S205 is executed. On the other hand, when there is not another piece of stop history information in the database stored in the server 20, S203 is executed. Therefore, for example, when the vehicle 10 repeatedly stops and moves for short time due to traffic congestion for long distance, it is possible to prevent multiple pieces of stop history information for the same congestion section from being stored in the database. Information on the stop location may be acquired as a latitude and a longitude, and may be information on a circular area including a predetermined range. The predetermined range can be set to any range. The area may be set in any shape, such as rectangular or elliptical along a road.

S203: The controller 24 determines whether the number of pieces of stop history information stored in the database is at an upper limit.

When the number of pieces of stop history information stored in the database is equal to the upper limit, the controller 24 executes S204. On the other hand, when the number of pieces of stop history information stored in the database is less than the upper limit, the controller 24 executes S205. The upper limit of the number of pieces of information can be set to any number. This allows the latest traffic conditions to be always reflected in the stop history information stored in the server 20.

S204: The controller 24 overwrites the oldest piece of stop history information stored in the database with the received stop history information.

Specifically, when the number of pieces of stop history information stored in the database of the server 20 is equal to the upper limit, the controller 24 overwrites the oldest piece of stop history information stored in the database with the received stop history information. This allows the latest traffic conditions to be always reflected in the stop history information stored in the server 20.

S205: The controller 24 stores the received stop history information in the database.

Specifically, when there is, in the database, another piece of stop history information whose stop time and stop location both approximately match with those of the received stop history information, the controller 24 overwrites the other piece of stop history information stored in the database, whose stop time and stop location both approximately match, with the received stop history information. This allows the latest traffic conditions to be always reflected in the stop history information. The stop history information may be overwritten, for example, by averaging latitude and longitude values of the stop locations in the stop history information, before and after the overwrite. This allows for more accurate records of the stop location information when there is a distance between the front and rear, such as when waiting at a signal. On the other hand, when there is not, in the database, another piece of stop history information whose stop time and stop location both approximately match with those of the received stop history information, and the number of pieces of stop history information stored in the database is less than the upper limit, the controller 24 stores the stop history information in the database.

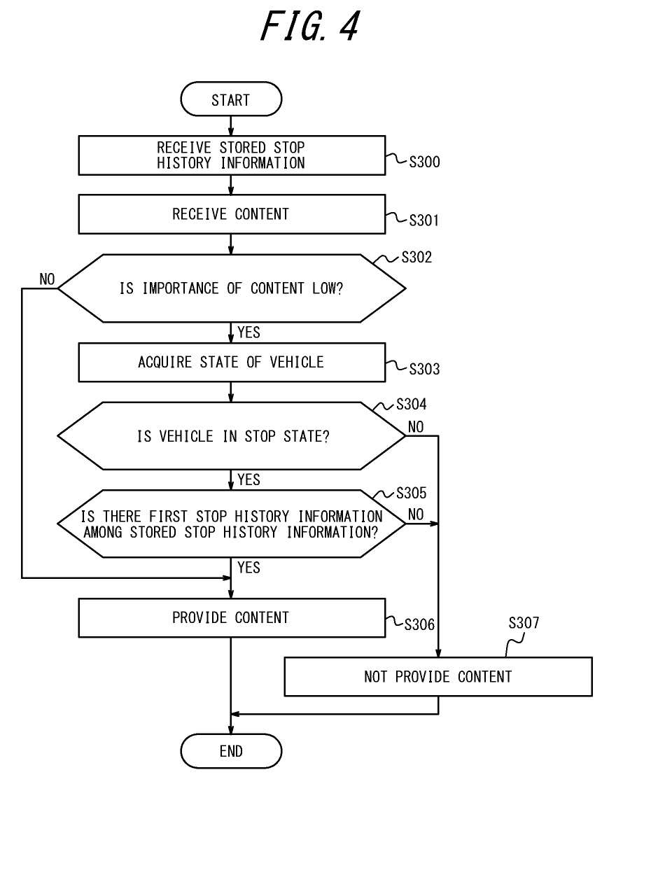

With reference to FIG. 4, operations of providing content to an occupant in the system according to the present embodiment will be described.

S300: The controller 24 of the server 20 transmits, to the vehicle 10, multiple pieces of stop history information stored in the database.

The stop history information may be transmitted from the server 20 at regular intervals, or may be transmitted when the server 20 receives a request from the vehicle 10. The number of pieces of stop history information to be transmitted can be set to any number. The number of pieces of stop history information to be transmitted may be dynamically changed based on the processing speed, communication speed, or the like of the vehicle 10. This makes it possible to transmit an appropriate amount of information for each vehicle.

S301: The controller 24 transmits content, which has been received via the network 30, to the vehicle 10.

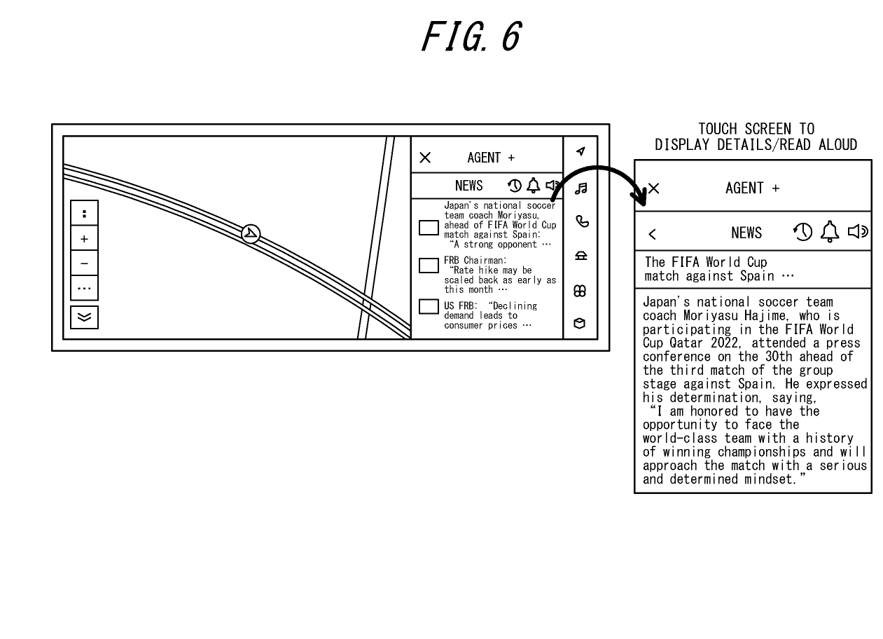

Specifically, the controller 24 receives content from the content server via the network 30, and transmits the content to the vehicle 10 via the network 30. The content may be transmitted from the server 20 at regular intervals, or may be transmitted when the server 20 receives a request from the vehicle 10. The content may include first content and second content. The first content may include any information of relatively low importance that should not necessarily be presented while the vehicle 10 is in motion from the perspective of driver distraction, such as notification information about applications, news information, or recommended spots, events, or souvenir information at a current location, on a route to a destination, and around the destination. On the other hand, the second content includes any information of relatively high importance that should be presented regardless of the state of the vehicle 10 (whether the vehicle 10 is in motion or stopped), such as traffic information on routes to frequently visited places, traffic information on a route to a destination, slip information on surrounding roads, speed warnings based on driving speed, and care guidance that is notified when drowsy driving is detected during highway driving. FIG. 6 illustrates an example of providing news information, which is one item of the first content, to the occupant.

S302: The controller 14 of the vehicle 10 determines whether second content has been received.

The controller 14 determines, based on details on the content, whether the content is first content or second content. When the first content has been received, the controller 14 executes S303. On the other hand, when the second content has been received, the controller 14 executes S306.

S303: The controller 14 acquires a location and a travel speed of the vehicle 10.

Any method can be adopted to acquire the location and the travel speed of the vehicle 10.

S304: The controller 14 detects a stop state of the vehicle 10 based on the travel speed of the vehicle 10.

The controller 14 may determine that the vehicle 10 is in a stop state when the travel speed of the vehicle 10 is equal to or lower than a predetermined value. When the vehicle 10 is repeatedly stopping and moving for a short time due to traffic congestion, the controller 14 may also determine that the vehicle 10 is in a stop state. Furthermore, the vehicle 10 may check the state of surrounding vehicles, and determine that the vehicle 10 is in a stop state based on the speed of the vehicle 10 and the state of the surrounding vehicles. Any method can be adopted to check the state of surrounding vehicles, such as sensors or in-vehicle cameras. The controller 14 executes S305 upon determining that the vehicle 10 is in a stop state, whereas the controller 14 executes S307 upon determining that the vehicle 10 is not in a stop state.

S305: Upon detecting the stop state of the vehicle 10, the controller 14 determines whether there is, among the multiple pieces of stop history information, first stop history information whose stop location approximately matches with that of stop history information at the time of detecting the stop state.

When there is, among the multiple pieces of stop history information, first stop history information whose stop location approximately matches with that of the stop history information at the time of detecting the stop state, the controller 14 determines that the vehicle 10 is highly likely to be stopped at the current stop location for a certain period of time or more, and executes S306. On the other hand, when there is not, among the multiple pieces of stop history information, first stop history information whose stop location approximately matches with that of the stop history information at the time of detecting the stop state, the controller 14 determines that the vehicle 10 is highly likely not to be stopped for the certain period of time or more, and executes S307.

In a case in which the stop history information includes a time zone, when there is, among the multiple pieces of stop history information, first stop history information whose stop location and stop time zone approximately match with those of the stop history information at the time of detecting the stop state, the controller 14 may determine that the vehicle 10 is highly likely to be stopped at the current stop location for the certain period of time or more, and execute S306.

S306: Upon detecting the stop state of the vehicle 10, the controller 14 provides the first content to the occupant when there is, among the multiple pieces of stop history information, first stop history information whose stop location approximately matches with that of the stop history information at the time of detecting the stop state. On the other hand, when the second content has been received, the controller 14 provides the second content to the occupant regardless of the state of the vehicle 10.

S307: The controller 14 does not provide the first content to the occupant.

The first content is not necessarily required during driving, and therefore is provided to the occupant when the above conditions are met. This makes it possible to prevent the occurrence of driver distraction.

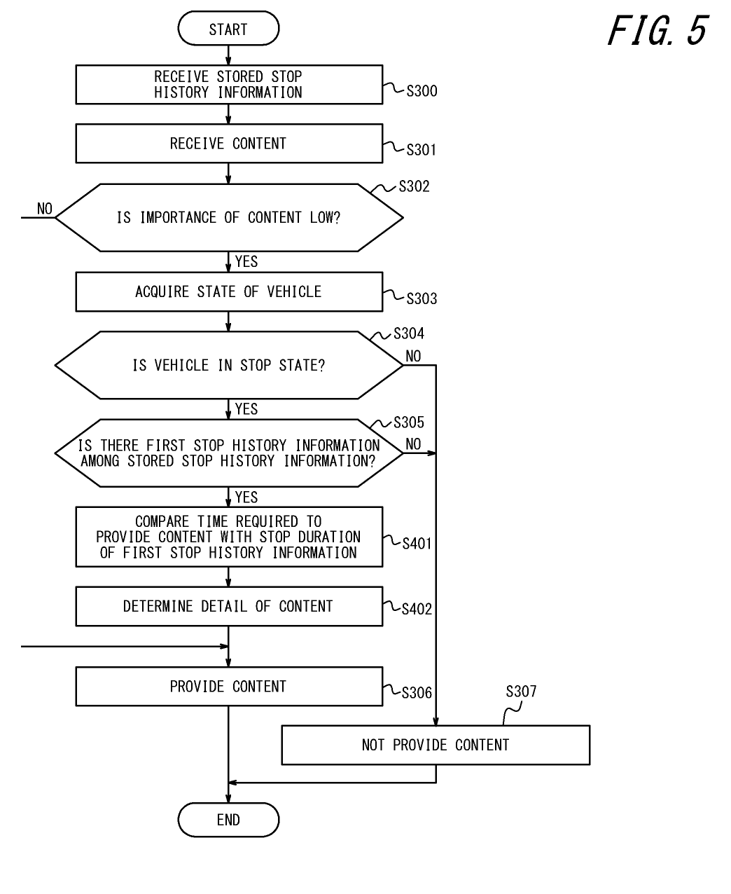

With reference to FIG. 5, operations of determining details on content to be provided by the system according to the embodiment of the present disclosure will be described.

S401: The controller 14 determines whether the time required to provide the first content is shorter than or equal to a stop duration included in the first stop history information.

The first stop history information includes the stop location, a stop time, and the stop duration. The controller 14 compares the time required to provide the first content with the stop duration of the first stop history information at the stop location.

S402: When the time required to provide the first content is shorter than or equal to the stop duration included in the first stop history information, the controller 14 provides the first content to the occupant.

When the time required to provide the first content is shorter than the stop duration of the first stop history information stored in the database, the controller 14 provides the first content to the occupant. This allows for appropriate selection of the first content that can be provided within the stop duration. The first stop history information may further include any information such as traffic volume information for a time zone of the stop time or at the stop location. The traffic volume information at the stop location may be used for detecting, for example, a location at which congestion due to an accident has occurred. At such a location, the time required to provide the first content plus a predetermined time may be compared with the stop duration of the stored stop history information. This makes it possible to prevent the occurrence of driver distraction.

As described above, the method according to the present embodiment is a method performed by a system that includes a vehicle and a server. The method includes acquiring, by the vehicle, a location and a travel speed of the vehicle, detecting, by the vehicle, a stop state of the vehicle based on the travel speed of the vehicle, and transmitting, by the vehicle to the server, stop history information including a stop location and a stop time, when a stop duration during which the stop state of the vehicle has continued is equal to or longer than a certain period of time.

According to such a configuration, when the stop state of the vehicle has been kept for the certain period of time, the stop history information including the stop location and the stop time is transmitted to the server. That is, the server stores a history of locations at which occupants have been actually stopped for the certain period of time or more. Therefore, when the vehicle provides content to an occupant, it is possible to take into account not only the state of the vehicle but also the stop history information on the vehicle. Thus, it is possible to prevent a situation in which content is provided to an occupant at a stop location with a relatively short stop duration and this results in driver distraction, thereby improving technology for appropriately determining the stop state of vehicles to provide information to occupants.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the server 20 in the above embodiment are distributed to multiple computers capable of communicating with each other can be implemented. For example, an embodiment in which some or all of the components of the server 20 are provided in the vehicle 10 can also be implemented. For example, a navigation apparatus mounted in the vehicle 10 may be equipped with some or all of the components of the server 20.

The above embodiment has described an example in which, in S300, the controller 14 receives only the stop history information on the own vehicle. Here, the stop history information that the controller 14 receives from the server 20 may include stop history information on the own vehicle and other vehicles. When the stop history information on the own vehicle and other vehicles is received, the stop history information may be received by determining the total number of pieces of stop history information to be received. The stop history information on other vehicles may be received by being limiting to stop history information regarding surrounding roads of the own vehicle traveling, a route to a destination, or surrounding roads of the destination. This allows for acquisition of the stop history information even in places in which the own vehicle has not traveled, enabling the provision of content to the occupant at appropriate locations while preventing the occurrence of driver distraction.

In the above embodiment, when the stored stop history information is received from the server, only some relevant information, such as information on surrounding roads of the vehicle traveling, a route to a destination, or surrounding roads of the destination, may be received. This allows for a reduction in communication volume and communication cost.

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A method performed by a system comprising a vehicle and a server, the system configured to provide content to an occupant of the vehicle while the vehicle is stopped, the method comprising: acquiring, by the vehicle, a location and a travel speed of the vehicle; detecting, by the vehicle, a stop state of the vehicle based on the travel speed of the vehicle; and transmitting, by the vehicle to the server, stop history information including a stop location and a stop time, when a stop duration during which the stop state of the vehicle has continued is equal to or longer than a certain period of time.

[Appendix 2] The method according to appendix 1, further comprising: storing, by the server, one or more pieces of stop history information in a database; receiving, by the server, the stop history information from the vehicle; determining, by the server, whether there is, in the database, another piece of stop history information whose stop time approximately matches with that of the received stop history information; determining, by the server, whether there is, in the database, another piece of stop history information whose stop location approximately matches with that of the received stop history information; and when there is, in the database, another piece of stop history information whose stop time and stop location both approximately match with those of the received stop history information, overwriting the other piece of stop history information with the received stop history information.

[Appendix 3] The method according to appendix 1 or 2, further comprising: when there is not, in the database, another piece of stop history information whose stop time and stop location both approximately match with those of the received stop history information, storing, by the server, the received stop history information in the database when a number of pieces of stop history information stored in the database is less than an upper limit; and overwriting, by the server, an oldest piece of stop history information stored in the database with the received stop history information when the number of pieces of stop history information stored in the database is equal to the upper limit.

[Appendix 4] The method according to appendices 1 to 3, further comprising: transmitting, by the server to the vehicle, first content received via a network and multiple pieces of stop history information stored in the database; and upon detecting a stop state of the vehicle, providing, by the vehicle, the first content to the occupant when there is, in the multiple pieces of stop history information, first stop history information whose stop location approximately matches with that of stop history information at a time of detecting the stop state.

[Appendix 5] The method according to appendix 4, further comprising: transmitting, by the server, second content to the vehicle; and upon receiving the second content, providing, by the vehicle, the second content to the occupant regardless of a state of the vehicle.

[Appendix 6] The method according to appendix 4 or 5, wherein the stop history information further includes a stop duration, and when time required to provide the first content is shorter than or equal to a stop duration included in the first stop history information, the vehicle is configured to provide the first content to the occupant.

[Appendix 7] The method according to appendices 1 to 3, wherein the server is configured to receive stop history information from multiple vehicles, and store the stop history information in the database.

[Appendix 8] A system comprising: a vehicle; and a server, wherein the system is configured to provide content to an occupant of the vehicle while the vehicle is stopped, the vehicle is configured to: acquire a location and a travel speed of the vehicle; detect a stop state of the vehicle based on the travel speed of the vehicle; and transmit stop history information including a stop location and a stop time to the server, when a stop duration during which the stop state of the vehicle has continued is equal to or longer than a certain period of time.

[Appendix 9] The system according to appendix 8, wherein the server is configured to: store one or more pieces of stop history information in a database; receive the stop history information from the vehicle; determine whether there is, in the database, another piece of stop history information whose stop time approximately matches with that of the received stop history information; determine whether there is, in the database, another piece of stop history information whose stop location approximately matches with that of the received stop history information; and when there is, in the database, another piece of stop history information whose stop time and stop location both approximately match with those of the received stop history information, overwrite the other piece of stop history information with the received stop history information.

[Appendix 10] The system according to appendix 8 or 9, wherein when there is not, in the database, another piece of stop history information whose stop time and stop location both approximately match with those of the received stop history information, the server is configured to: store the received stop history information in the database when a number of pieces of stop history information stored in the database is less than an upper limit; and overwrite an oldest piece of stop history information stored in the database with the received stop history information when the number of pieces of stop history information stored in the database is equal to the upper limit.

[Appendix 11] The system according to appendices 8 to 10, wherein the server is configured to transmit, to the vehicle, first content received via a network and multiple pieces of stop history information stored in the database, and the vehicle is configured to, upon detecting a stop state of the vehicle, provide the first content to the occupant when there is, in the multiple pieces of stop history information, first stop history information whose stop location approximately matches with that of stop history information at a time of detecting the stop state.

[Appendix 12] The system according to appendix 11, wherein the server is configured to transmit second content to the vehicle, and the vehicle is configured to, upon receiving the second content, provide the second content to the occupant regardless of a state of the vehicle.

[Appendix 13] The system according to appendix 11 or 12, wherein the stop history information further includes a stop duration, and when time required to provide the first content is shorter than or equal to a stop duration included in the first stop history information, the vehicle is configured to provide the first content to the occupant.

[Appendix 14] The system according to appendices 8 to 10, wherein the server is configured to receive stop history information from multiple vehicles, and store the stop history information in the database.

1. A method performed by a system comprising a vehicle and a server, the system configured to provide content to an occupant of the vehicle while the vehicle is stopped, the method comprising:
acquiring, by the vehicle, a location and a travel speed of the vehicle;
detecting, by the vehicle, a stop state of the vehicle based on the travel speed of the vehicle; and
transmitting, by the vehicle to the server, stop history information including a stop location and a stop time, when a stop duration during which the stop state of the vehicle has continued is equal to or longer than a certain period of time.

2. The method according to claim 1, further comprising:
storing, by the server, one or more pieces of stop history information in a database;
receiving, by the server, the stop history information from the vehicle;
determining, by the server, whether there is, in the database, another piece of stop history information whose stop time approximately matches with that of the received stop history information;
determining, by the server, whether there is, in the database, another piece of stop history information whose stop location approximately matches with that of the received stop history information; and
when there is, in the database, another piece of stop history information whose stop time and stop location both approximately match with those of the received stop history information, overwriting the other piece of stop history information with the received stop history information.

3. The method according to claim 2, further comprising:
when there is not, in the database, another piece of stop history information whose stop time and stop location both approximately match with those of the received stop history information, storing, by the server, the received stop history information in the database when a number of pieces of stop history information stored in the database is less than an upper limit; and
overwriting, by the server, an oldest piece of stop history information stored in the database with the received stop history information when the number of pieces of stop history information stored in the database is equal to the upper limit.

4. The method according to claim 3, further comprising:
transmitting, by the server to the vehicle, first content received via a network and multiple pieces of stop history information stored in the database; and
upon detecting a stop state of the vehicle, providing, by the vehicle, the first content to the occupant when there is, in the multiple pieces of stop history information, first stop history information whose stop location approximately matches with that of stop history information at a time of detecting the stop state.

5. The method according to claim 4, further comprising:
transmitting, by the server, second content to the vehicle; and
upon receiving the second content, providing, by the vehicle, the second content to the occupant regardless of a state of the vehicle.

6. The method according to claim 4, wherein
the stop history information further includes a stop duration, and
when time required to provide the first content is shorter than or equal to a stop duration included in the first stop history information, the vehicle is configured to provide the first content to the occupant.

7. The method according to claim 3, wherein the server is configured to receive stop history information from multiple vehicles, and store the stop history information in the database.

8. A system comprising:
a vehicle; and
a server,
wherein
the system is configured to provide content to an occupant of the vehicle while the vehicle is stopped,
the vehicle is configured to:
acquire a location and a travel speed of the vehicle;
detect a stop state of the vehicle based on the travel speed of the vehicle; and
transmit stop history information including a stop location and a stop time to the server, when a stop duration during which the stop state of the vehicle has continued is equal to or longer than a certain period of time.

9. The system according to claim 8, wherein the server is configured to:
store one or more pieces of stop history information in a database;
receive the stop history information from the vehicle;
determine whether there is, in the database, another piece of stop history information whose stop time approximately matches with that of the received stop history information;
determine whether there is, in the database, another piece of stop history information whose stop location approximately matches with that of the received stop history information; and
when there is, in the database, another piece of stop history information whose stop time and stop location both approximately match with those of the received stop history information, overwrite the other piece of stop history information with the received stop history information.

10. The system according to claim 9, wherein when there is not, in the database, another piece of stop history information whose stop time and stop location both approximately match with those of the received stop history information, the server is configured to:
store the received stop history information in the database when a number of pieces of stop history information stored in the database is less than an upper limit; and
overwrite an oldest piece of stop history information stored in the database with the received stop history information when the number of pieces of stop history information stored in the database is equal to the upper limit.

11. The system according to claim 10, wherein
the server is configured to transmit, to the vehicle, first content received via a network and multiple pieces of stop history information stored in the database, and
the vehicle is configured to, upon detecting a stop state of the vehicle, provide the first content to the occupant when there is, in the multiple pieces of stop history information, first stop history information whose stop location approximately matches with that of stop history information at a time of detecting the stop state.

12. The system according to claim 11, wherein
the server is configured to transmit second content to the vehicle, and
the vehicle is configured to, upon receiving the second content, provide the second content to the occupant regardless of a state of the vehicle.

13. The system according to claim 11, wherein
the stop history information further includes a stop duration, and
when time required to provide the first content is shorter than or equal to a stop duration included in the first stop history information, the vehicle is configured to provide the first content to the occupant.

14. The system according to claim 10, wherein the server is configured to receive stop history information from multiple vehicles, and store the stop history information in the database.
